(19) United States
(12) Patent Application Publication
(10) Pub. No.: US 2017/0212570 A1
(43) Pub. Date: Jul. 27, 2017

(54) Backup Power Assembly Having Blind Mate Connector

(71) Applicant: HEWLETT PACKARD ENTERPRISE DEVELOPMENT LP, Houston, TX (US)

(72) Inventors: John NORTON, Houston, TX (US); Arnold Nicholas TOP, Houston, TX (US); Joseph Roy ALLEN, Tomball, TX (US); Chanh V HUA, Houston, TX (US)

(21) Appl. No.: 15/329,248

(22) PCT Filed: Jul. 31, 2014
(86) PCT No.: PCT/US2014/049306

§ 371 Date: Jan. 25, 2017

(51) Int. Cl. G06F 1/26; G06F 1/32; G06F 1/30; G06F 1/18

(52) U.S. Cl. CPC G06F 1/263; G06F 1/188; G06F 1/3212; G06F 1/305

(57) ABSTRACT

A computer system including a chassis having a first chassis component and a backup power source. The backup power source, including a battery pack and a blind mate connector, selectively mounted to the first chassis component, the battery pack electrically connected to the blind mate connector, the backup power source and first chassis component together forming a backup power assembly, wherein the blind mate connector of the backup power source engages a corresponding blind mate connector of the computer system to electrically connect the backup power source to a power supply system of the computer system when the backup power assembly is installed in the computer system, and wherein the first chassis component provides a computer system function unrelated to the backup power source

### BACKGROUND

Computers, including rack servers, for example, typically employ back power sources to maintain information stored in volatile storage in the event of power failure. In this way, data will not be lost as a result of an unexpected power outage. Such power sources include replaceable battery systems that can be inserted into and removed from the computer.

### BRIEF DESCRIPTION OF THE DRAWINGS

FIG. 1 is a partially exploded perspective view of portions computer system having a backup power assembly according to one example.

FIG. 2 is a partially exploded perspective view of portions computer system having a backup power assembly according to one example.

FIG. 3 is a perspective view of a backup power assembly according to one example.

FIG. 4 is a partially exploded perspective view of portions computer system having a backup power assembly according to one example.

FIG. 5 is a partially exploded perspective view of portions computer system having a backup power assembly according to one example.

FIG. 6 is a perspective view illustrating portions of a backup power assembly according to one example.

FIG. 7 is a perspective view illustrating portions of a blind mate connector of a backup power assembly according to one example.

FIG. 8 is a perspective view illustrating alignment features of a backup power assembly according to one example.

FIG. 9 is a perspective view illustrating portions of computer system including a backup power assembly according to one example.

FIG. 10 is a perspective view illustrating portions of computer system including a backup power assembly according to one example.

FIG. 11 is a perspective view illustrating portions of computer system including a backup power assembly according to one example.

FIG. 12 is a perspective view illustrating portions of computer system including a backup power assembly according to one example.

FIG. 13 is a flow diagram generally illustrating a method of providing backup power for a computer system according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Computers, such as rack servers, for example, typically use volatile storage to store data during operation. In order to prevent loss of information stored in volatile storage due to unexpected power outages and maintain system operation, computers typically employ backup power systems to maintain power, at least temporarily, during outages. Such backup power systems typically include removable batteries or battery packs which must sometimes be replaced. As space is often limited, removing and installing batteries of backup power systems from computers can be difficult, particularly when connecting and disconnecting the batteries to power supply circuitry within the computer. If not done properly, both the backup power systems and components of the computer can be damaged, particularly if proper alignment is not achieved between the backup power system and corresponding components of the computer, such as between electrical connection elements.

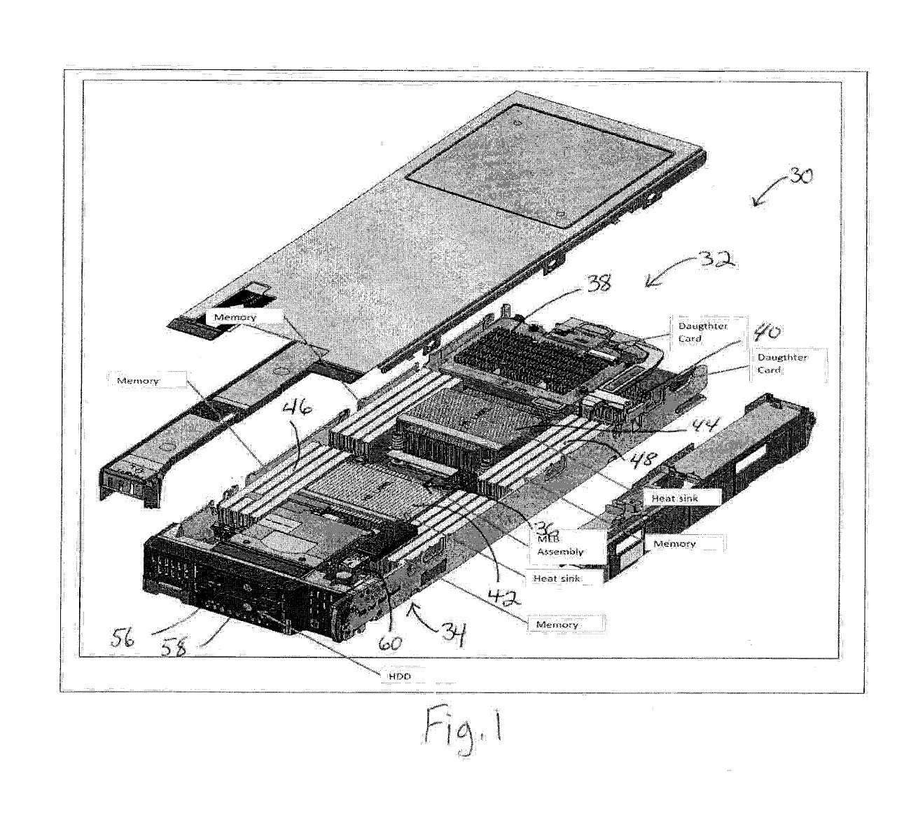

FIGS. 1-12 below illustrate a computer 30, in particular, a rack server 30, having a backup power source and blind mate connector selectively coupled to a chassis component of server 30 to form a backup power assembly, according to one example, which can be readily aligned with an inserted into and removed from server 30. In addition to supporting the backup power source and blind mate connector, the chassis component provides a function to server 30 unrelated to the backup power source. For instance, according to one example, the chassis component is an air baffle which directs cooling air flows through server 30.

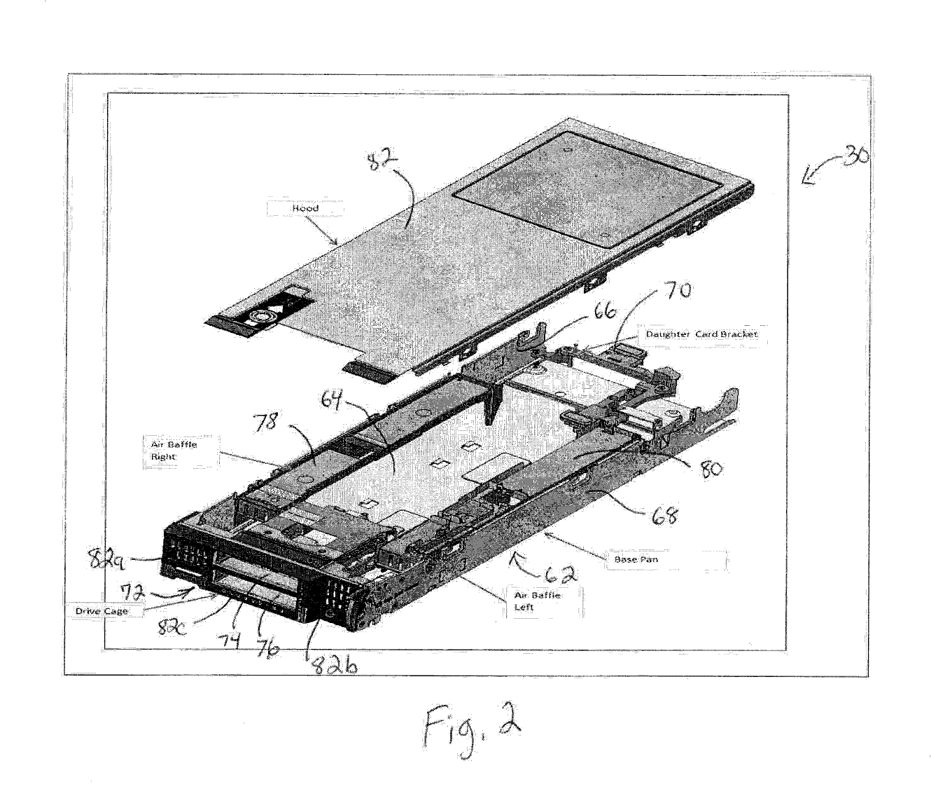

FIG. 1 is a partially exploded perspective view illustrating portions of server 30 including electronic components 32 and a chassis 34 (components of chassis 34 are illustrated in FIG. 2 below). Electronic components 32 include a main logic board (MLB) 36 and daughter cards 38 and 40, with MLB 36 further including central processing units (CPUs) 42 and 44, memory modules 46 and 48 (such as DIMMs, for example), hard disk drives (HDDs) 56 and 58, and power supply circuitry 60. Daughter cards 38 and 40 expand functionality of MLB 36 such as by providing network interface functions, communication functions, RAID (redundant array of inexpensive disk) controller functions, server management functions, and to enable installation of expansion cards, for example.

FIG. 2 is a perspective view of server 30 of FIG. 1 illustrating components of chassis 34. Chassis 34 includes a plurality of chassis components providing physical and mechanical functions for support of electronic components 32. In one example, chassis components include a base pan 62 having a base panel 64 and sidewalls 66 and 68, a daughter card bracket 70, a drive cage 72 with openings 74 and 76 for HDDs 56 and 58, air baffles 78 and 80 (sometimes referred to as “left” and “right” air baffles), and a hood 82. Note that left and right air baffles 78 and 80 are shown in a “removed” position in FIG. 1, so as to more clearly illustrate memory modules 46 and 48, over and around which left and right air baffles 78 and 80 are disposed when in an “installed” position. Drive cage 72 further includes pluralities of vent openings 82a, 82b, 82c which, as will be described in greater detail below, function as air intake vents for server 30.

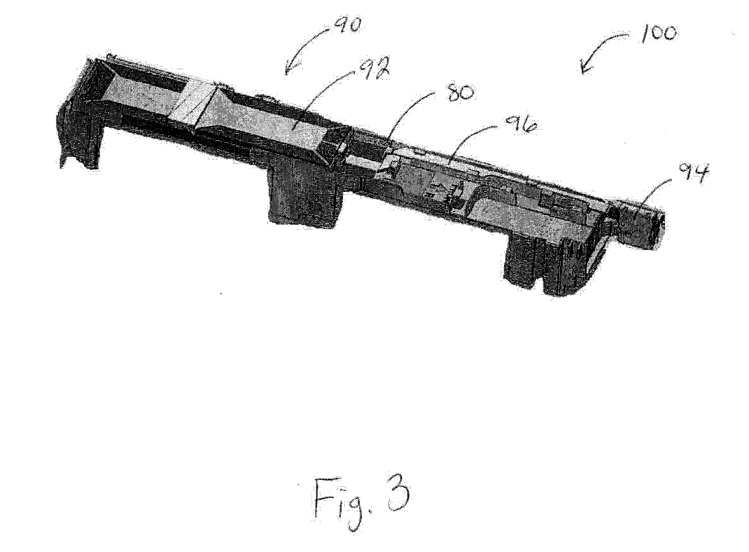

FIG. 3 is perspective view illustrating a backup power assembly 100, according to one example, which includes an air baffle, such as air baffle 80, and a backup power source 90 which is selectively installable within and removable from server 30 as a unit. According to one example, backup power source 90 includes a battery pack 92, a blind mate connector 94, and a cable 96 electrically connecting battery pack 92 with blind mate connector 94, each of which is selectively coupled to air baffle 80 so that backup power source 90 and air baffle 80 together form backup power assembly 100.

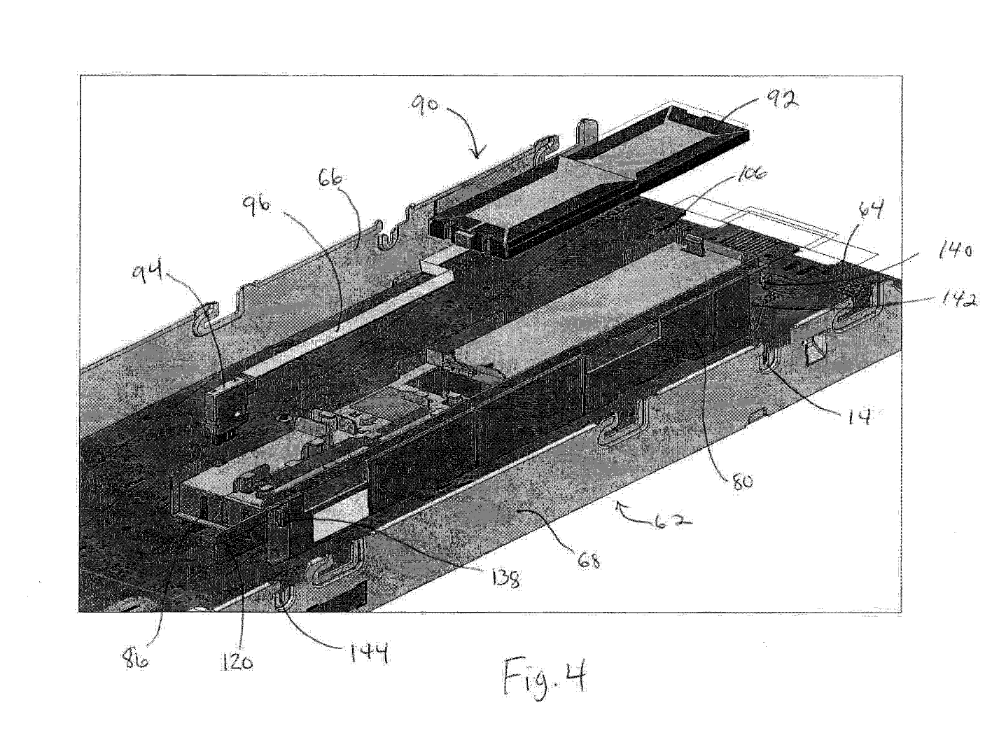

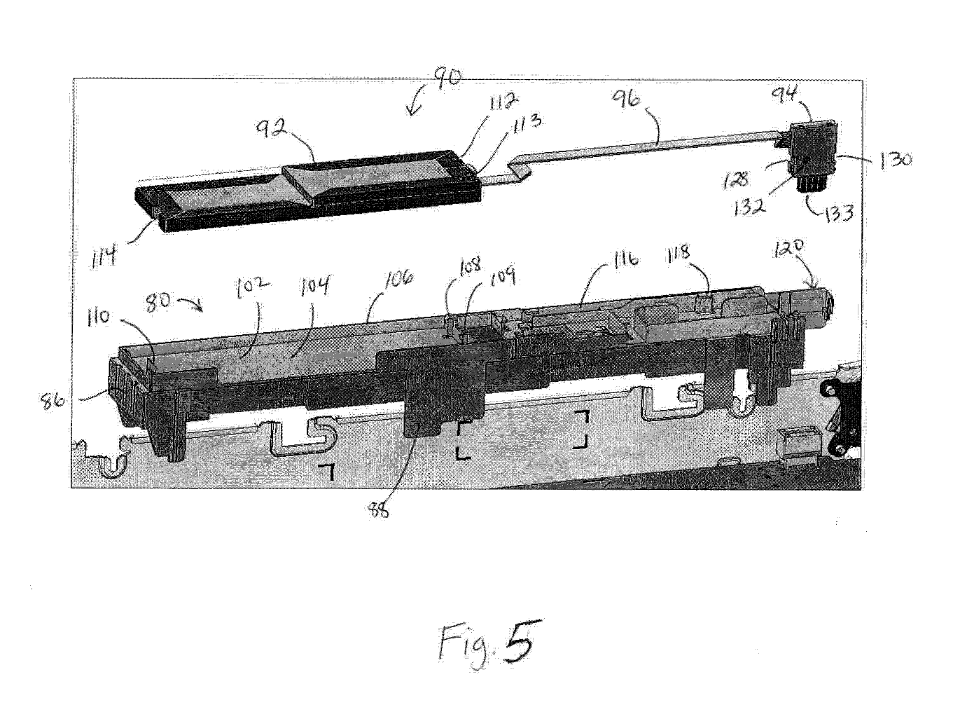

FIGS. 4 and 5 are partially exploded perspective views illustrating base pan 62 and backup power assembly 100, with backup power assembly being in a “removed” position from server 30 and backup power source 90 being in a “removed” position from air baffle 80. Air baffle 80 includes air intake vents 86 which receive cooling air flows from the vent openings in drive cage 72, such as vent openings 82b, and a plurality of support legs, such as support leg 88.

In one example, air baffle 80 includes an upper surface 102 having a battery pocket 104 configured to receive battery pack 92 and which is formed by a plurality of flange elements extending from upper surface 102, such as flange elements 106. Air baffle 80 includes fixed retainer posts 108, 109 and an elastic retainer clip 110 disposed within battery pocket 104 which engage corresponding notches 112, 113, and 114 in opposing ends of battery pack 92 and secure battery pack 92 within battery pocket 104. Air baffle 80 also includes a channel 116 in which cable 96 is disposed, including a plurality of retainer tabs, such as retainer tab 118, which maintain cable 96 within channel 116.

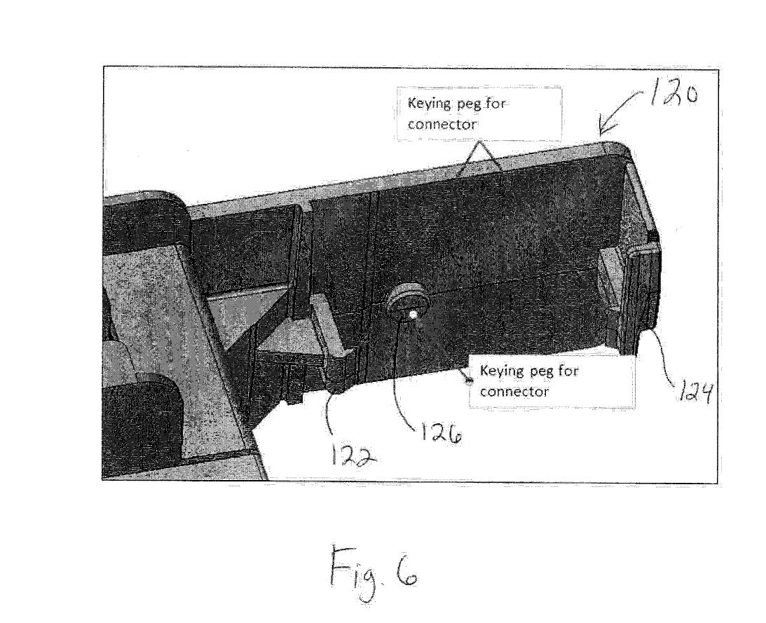

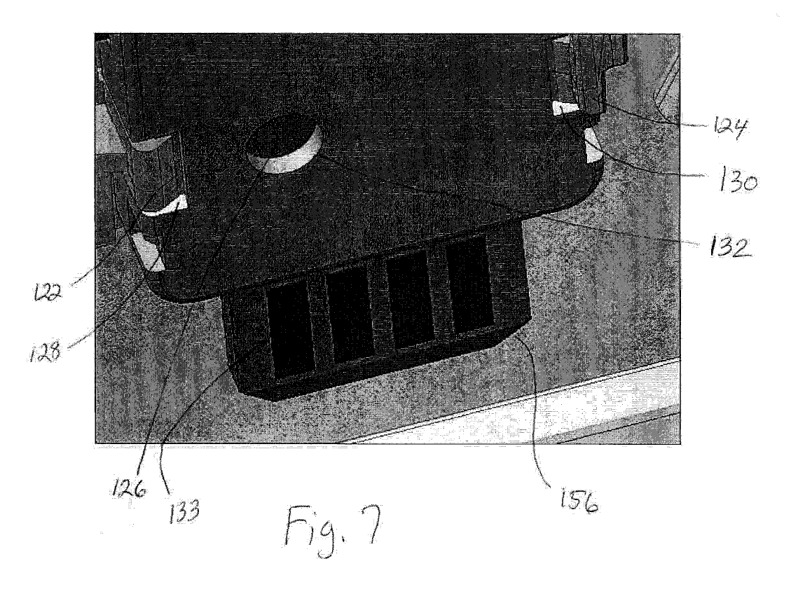

Air baffle 80 further includes a connector pocket 120 for selectively securing blind mate connector 94. FIG. 6 is a perspective view illustrating connector pocket 120 in greater detail. In one example, connector pocket 120 includes elastic retainer clips 122 and 124, and a key peg 126. As illustrated by FIG. 7, which is a perspective view illustrating blind mate connector 94 mounted in connector pocket 120, retainer clips 122 and 124 respectively engage notches 128 and 130 on opposing sides of blind mate connector 94, and key peg 126 is received into a corresponding key hole 132 in blind mate connector 94. Together, retainer clips 122, 124, key peg 126, notches 128, 130, and key 132 selectively secure blind mate connector 94 within connector pocket 120 and maintain electrical contacts 133 of blind mate connector 94 at a desired position relative to air baffle 80.

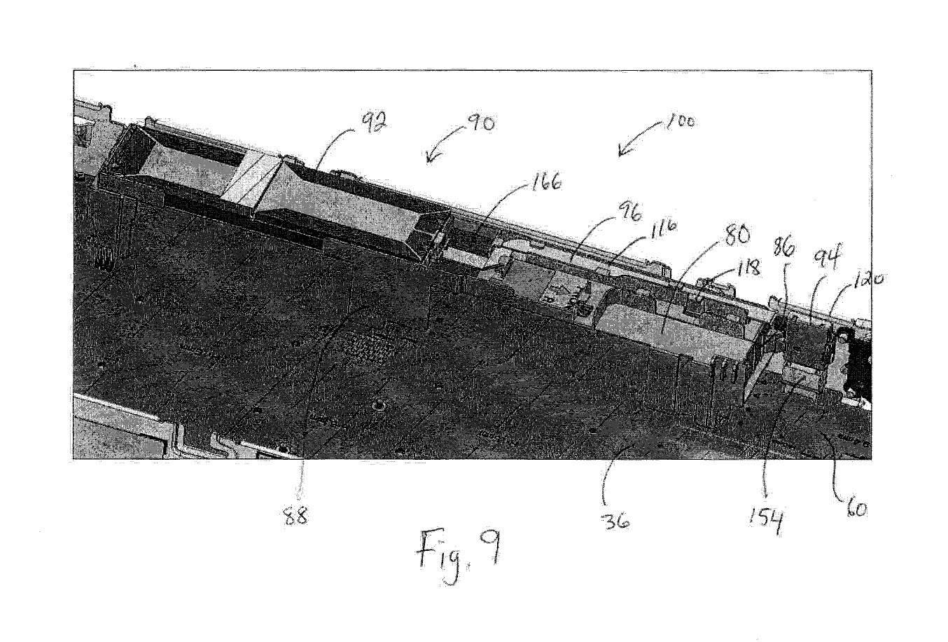

Although not illustrated, in other examples, blind mate connector 94 could be mounted directly to battery pack 92, which would eliminate cable 96 and connector pocket 120. Such an implementation could be employed where battery pack 92 is disposed proximate to a blind mate connector of power supply circuitry 60 (see blind mate connector 154 in FIG. 9 below).

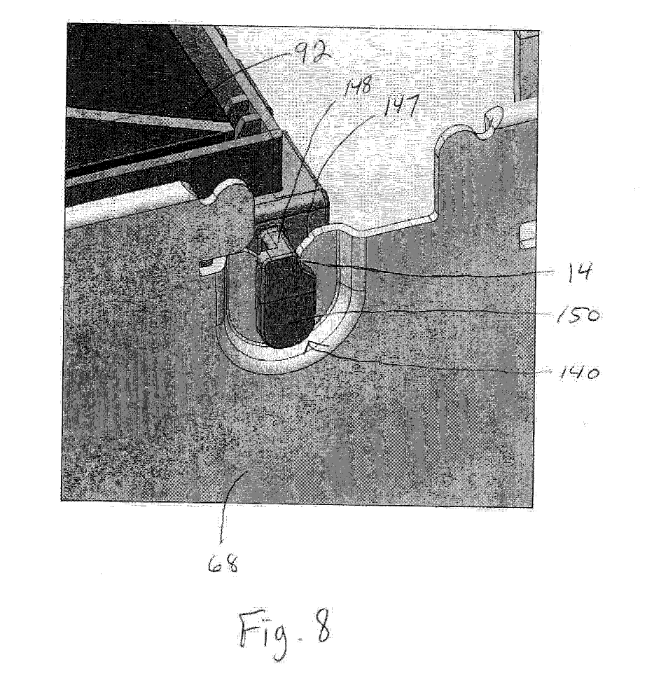

Air baffle 80 further includes alignment features 138 and 140 extending from a side surface 142 which are configured to be slideably received by corresponding alignment slots 144 and 146 in sidewall 68 of chassis 62. FIG. 8 is an enlarged perspective view illustrating alignment feature 140 positioned in alignment slot 146 in sidewall 68 of base pan 62. According to one example, alignment features 138 and 140, as illustrated with respect to alignment feature 140, include a shaft portion 148 capped with a tab portion 150 which is wider than shaft portion 148 so as to form a T-shape, with shaft portion 148 extending perpendicularly to side surface 142 and tab portion 150 extending parallel to side surface 142 of air baffle 80.

In other examples, it is noted that slot and tab configuration described above could be reversed, with the alignment slots, such as alignment slots 144 and 146, being located on air baffle 80, and alignment features 138 and 140 (e.g. shaft and tab 148 and 150) being located on chassis 62. In other examples, alignment features may be arranged between air baffle 80 and main logic board 36. In still other example, alignment features maybe be arranged between air baffle 80 and one or more other components of chassis 62 and main logic board 36.

When backup power assembly 100 is installed in server 30, chamfered openings 147 of alignment slots 144 and 146 receive and guide shaft portions 148 of alignment features 138 and 140 into alignment slots 144 and 146. Tab portions 150 engage sidewall 68 and hold alignment features 138 and 140 in place, thereby securing air baffle 80 and, thus, backup power assembly 100, in place against sidewall 68.

As illustrated by FIG. 9, alignment features 138, 140 and corresponding alignment slots 144, 146 are positioned such that when backup power assembly 100 is installed in chassis 34, blind mate connector 94 of backup power assembly 100 aligns with a corresponding blind mate connector 154 which is electrically connected to power supply circuitry 60 of server 30. In one example, blind mate connector 154 is mounted on main logic board 36 of server 30. As backup power assembly 100 is inserted into server 30 and pressed into place and alignment features 138, 140 reach a bottom of corresponding alignment slots 144 and 146, contacts 133 of blind mate connector 94 engage corresponding contacts in blind mate connector 154 and electrically connect backup power source 90 with power supply circuit 60.

In one example, alignment features 138, 140 and alignment slots 144, 146 provide a so-called “coarse” alignment of blind mate connector 94 with corresponding blind mate connector 154. According to such example, shaft portions 148 of alignment features 138, 140 and alignment slots 144, 146 are sized to enable a small amount of lateral movement of shaft portion 148 within alignment slots 144, 146. The small amount of lateral movement enables final alignment of blind mate connector 94 with corresponding blind mate connector 154 to be provided by chamfered edges 156 of contacts 133 of blind mate connector 94 (see FIG. 7) which guide blind mate connector 94 into corresponding blind mate connector 154. In one example, blind mate connector 94 is a male-type connector and corresponding blind mate connector 154 is a female-type connector.

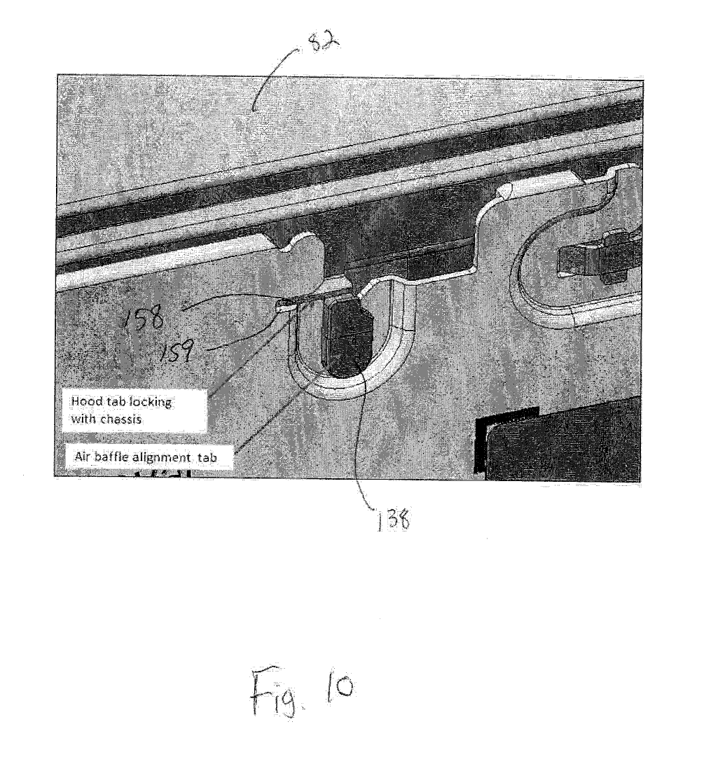

Hood 82 (see FIG. 2) is installed after installation of backup power assembly 100. As illustrated by FIG. 10, when hood 82 is installed, tabs 158 on a perimeter edge of hood 82 are received by slots 159 in sidewall 68 above alignment features 138 and 140 and lock alignment features 138 and 140 within alignment slots 144 and 146.

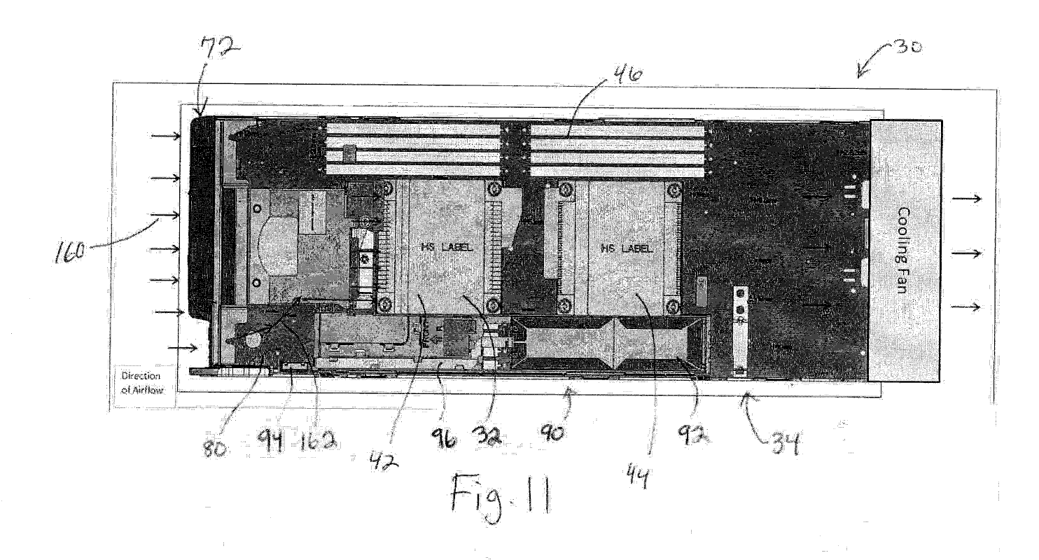

FIG. 11 is a top view illustrating backup power assembly 100 installed in server 30 with hood 82 being removed. In addition to supporting backup power source 90, air baffle 80 directs cooling air flows through server 30. In operation, cooling air, as indicated by arrows 160, is drawn into the interior of server 30 via vent openings 82a, 82b, 82c in drive cage 72 (see FIG. 2). In the absence of air baffle 80, cooling air flows would travel freely through chassis 34 and pass over memory modules 48. However, as indicated by arrow 162, air baffle 82 directs at least a portion of cooling air flows 160 to instead pass over processing units 42 and 44.

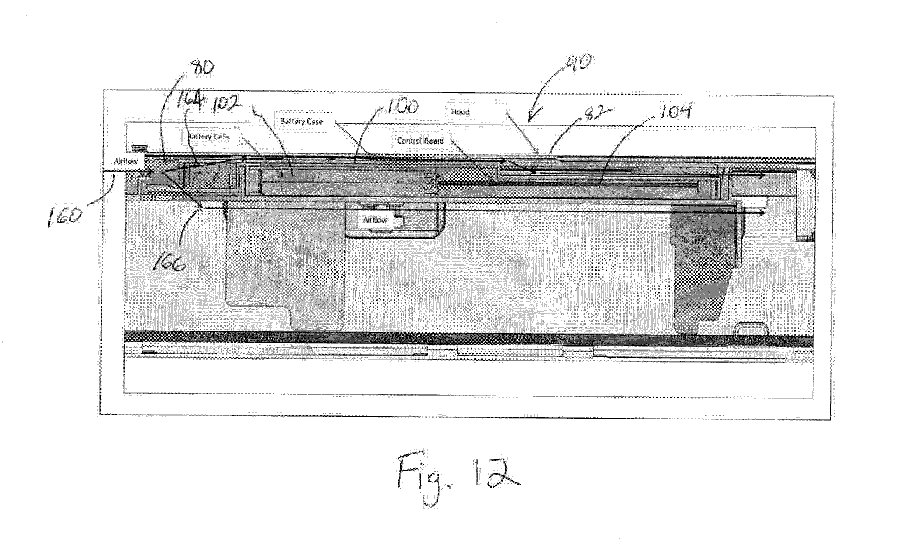

FIG. 12 is a cross-sectional view illustrating portions of server 30, including backup power assembly 100. In one example, battery pack 92 includes a battery case 100 housing battery cells 102 and a control board 104. In addition to directing cooling air flows 162 across processing units 42 and 44, in one example, air baffle 80 cools battery pack 92 by directing at a least a portion of cooling air flows 160 to flow above and below battery pack 92. In one example, air baffle 80 directs a portion of cooling air flow 160 to flow above battery pack 92 between hood 82 and batter case 100, as indicated by arrow 164, and directs a portion of cooling air flow 160, via an opening 166 in air baffle 80 (see FIG. 9), to flow below battery pack 92, as indicated by arrow 168.

Cooling air flows become progressively warmer as they enter via drive cage 72 and pass through server 30. In one example, backup power source 90 is mounted on air baffle 80 so that battery cells 102 are positioned closer to drive cage 72 than the portion of backup case 100 housing control board 104. In such a position, battery cells 102 are exposed to cooler air than if positioned with control board 104 closer to drive cage 72. In one example, such cooler air ensures proper operation and charging of battery cells 102.

While backup power assembly 100 is described herein primarily in terms of backup power source 90 being selectively mounted to an air baffle, such as air baffle 80, backup power source 90, according to the present disclosure, can be mounted to any suitable component of chassis 34 to form backup power assembly 100. For instance, in other examples, backup power source 90 may be mounted to components of chassis 34 such as base pan 62, drive cage 72, and hood 82, for example.

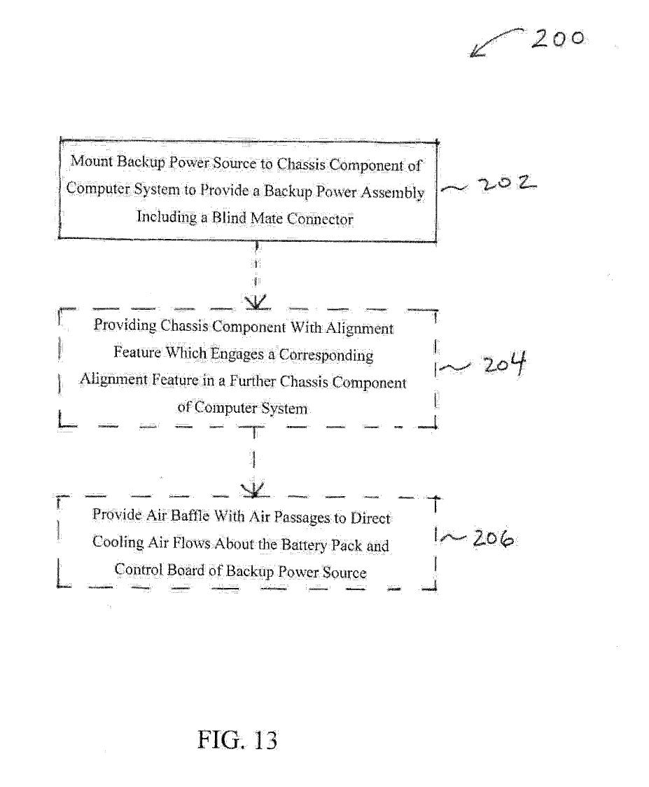

FIG. 13 is a flow diagram illustrating a method 200 of providing backup power to a computer system, such as computer system 30. At 202, method 200 includes selectively mounting a backup power source, such as backup power source 90, to a chassis component of a computer system, such as air baffle 80 of chassis 34 of computer system 30, to form a backup power assembly, such as backup power assembly 100. The backup power source includes a battery pack and a blind mate connector electrically connected thereto, such as battery pack 92 and blind mate connector 34 electrically connected to battery pack 92 by cable 96.

The blind mate connector engages a corresponding blind mate connector of the computer system to electrically connect the backup power source to power supply circuitry of the computer system when the backup power assembly is installed in the computer system, such as blind mate connector 94 engaging corresponding blind mate connector 154 to electrically connect backup power source 90 to power supply circuitry 60 when backup power assembly 100 is installed in computer system 30. In addition to providing a mounting platform for the backup power source, when installed in the computer system, the chassis component provided a function to the computer system which is unrelated to the backup power source, such as air baffle 80 directing cooling air flows through computer system 30 when backup power assembly 100 is installed therein.

In one example, as indicated at 204, method 200 further includes providing the chassis component with at least one alignment feature which engages a corresponding alignment feature in a further chassis component of the computer system to align the blind mate connector of the backup power assembly with the corresponding blind mate connector of the computer system, such as alignment features 138, 140 of air baffle 80 engaging corresponding alignment features 144, 146 in sidewall 68 of base pan 62 to align blind mate connector 94 with blind mate connector 154.

In one example, when the chassis component to which the backup power source is an air baffle, such as air baffle 80, method 200, at 206, further includes providing the air baffle with passages to direct cooling flows about the battery pack and a control board of the backup power source, such as air baffle 80 directing an air flow 164 between hood 82 and battery pack 92 and directing an air flow 168 below battery pack 92 via an baffle opening 166.

In summary, by selectively mounting backup power source 90 to a component of chassis 34 to form a backup power assembly 100 including a blind mate connector 94, backup power source 90 can be readily installed within and removed from a computer system, such as computer system 30, in a single step that ensures proper alignment and connection between electrical connection elements, such as blind mate connectors 94 and 154, even in tight spaces that would otherwise be inaccessible. Additionally, by using an existing chassis component, such as air baffle 80, which already provides an independent function to the computer system (e.g. directing cooling air flows), as a mounting platform for backup power source 90 to form backup power assembly 100, space is conserved by not providing a separate component dedicated solely to mounting of and support of the backup power source.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A computer system comprising:
a chassis including a first chassis component; and
a backup power source, including a battery pack and a blind mate connector, selectively mounted to the first chassis component, the battery pack electrically connected to the blind mate connector, the backup power source and first chassis component together forming a backup power assembly, wherein the blind mate connector of the backup power source engages a corresponding blind mate connector of the computer system to electrically connect the backup power source to a power supply system of the computer system when the backup power assembly is installed in the computer system, and wherein the first chassis component provides a computer system function unrelated to the backup power source.

2. The computer system of claim 1, wherein the first chassis component comprises an air baffle directing cooling air flows through the computer system.

3. The computer system of claim 2, wherein the air baffle directs cooling air flows between a hood of the chassis and the battery pack and between a base plate of the chassis and the battery pack.

4. The computer system of claim 1, wherein the first chassis component comprises one of a hood, a drive cage, and a base pan.

5. The computer system of claim 1, wherein the blind mate connector of the backup power assembly comprises a male connector the corresponding blind mate connector of the computer system comprises a female connector.

6. The computer system of claim 1, wherein the first chassis component includes alignment features which engage corresponding alignment features in a second chassis component to position the backup power assembly so that the blind mate connector of the backup power assembly aligns with the corresponding blind mate connector of the computer system.

7. The computer system of claim 1, wherein the corresponding blind mate connector of the computer system is mounted to a main logic board of the computer system.

8. A backup power assembly for a computer system comprising:
an air baffle directing cooling air flows within the computer system, the air baffle including at least one alignment element;
a first blind mate connector selectively mounted to the air baffle;
a battery pack selectively mounted to the air baffle and electrically connected to the first blind mate connector, wherein the at least one alignment element engages a corresponding guide element in at least one of a main logic board and a chassis of the computer system to align the first blind mate connector with a corresponding second blind mate connector of the computing system to electrically connect the backup power assembly to power supply circuitry of the computer system when the backup power assembly is installed in the computer system.

9. The backup power assembly of claim 8, wherein the air baffle includes passages directing cooling air flows between a hood of the chassis and the battery pack and between a base plate of the chassis and the battery pack.

10. The backup power assembly of claim 9, wherein battery cells of the battery pack are positioned upstream in the cooling air flows relative to a control board of the battery pack.

11. The backup power assembly of claim 8, wherein the at least one alignment element of the backup power assembly comprises a tab extending from a surface of the air baffle and the corresponding guide element comprises a slot in a base pan of the chassis which receives the tab.

12. The backup power assembly of claim 8, wherein the first blind mate connector comprises one of a male connector and a female connector.

13. A method of providing backup power for a computer system comprising:
selectively mounting a backup power source to a chassis component of the computer system to provide a backup power assembly, the backup power source including a battery pack and a blind mate connector electrically connected thereto, wherein the blind mate connector engages a corresponding blind mate connector of the computer system to electrically connect the backup power source to power supply circuitry of the computer system when the backup power assembly is installed in the computer system, the chassis component providing a function unrelated to the backup power assembly when installed in the computer system.

14. The method of claim 18, further including providing the chassis component with at least one alignment feature which engages a corresponding alignment feature in a further chassis component of the computer system to position the backup power assembly so that the blind mate connector of the backup power assembly aligns with the corresponding blind mate connector.

15. The method of claim 18, wherein the chassis component comprises an air baffle for directing cooling air flows through the computer system, the method further including providing the air baffle with air passages to direct cooling air flows about the battery pack and a control board of the backup power source.
